(19) United States
(12) Patent Application Publication
(10) Pub. No.: US 2019/0148813 A1
(43) Pub. Date: May 16, 2019

(54) IMAGING SYSTEM AND METHOD FOR ACCURATELY DIRECTING ANTENNAS

(71) Applicant: Tomer Bruchiel, Holon (IL)

(72) Inventor: Tomer Bruchiel, Holon (IL)

(21) Appl. No.: 16/098,881

(22) PCT Filed: Jul. 13, 2017
(86) PCT No.: PCT/IL2017/050796

§ 371 Date: Nov. 5, 2018

Related U.S. Application Data
(60) Provisional application No. 62/361,597, filed on Jul. 13, 2016.

(51) Int. Cl. H01Q 1/12; H01Q 3/04; G01S 19/53

(52) U.S. Cl. CPC H01Q 1/125; G01S 19/53; H01Q 3/04

(57) ABSTRACT

An imaging system for accurately determining a pointing direction of a directional antenna, which comprises a digital camera for capturing an elevation-view image of surroundings of a rotatable directional antenna, where the camera is suitably connected to the antenna such that the field of view of the camera is parallel to a primary transmission direction of the antenna; a processing unit for receiving and processing image data generated by the camera; and an input device for selecting a landmark that is visible in the captured image. The processing unit is operable to determine a true azimuth of the selected landmark, sufficiently process the image data so as to output therefrom an angle in plan view from the antenna to the landmark, and to combine the output angle to the true azimuth of the selected landmark to determine a pointing direction of the antenna.

### FIELD OF THE INVENTION

The present invention belongs to the field of directional antennas. More particularly, the invention relates to a system and method for the alignment of a directional antenna to a predetermined azimuth.

### BACKGROUND OF THE INVENTION

It is well known in the field of directional antennas, such as for example cellular communication antennas, that imprecise alignment of the antenna leads to weaker signal transmission and reception to and from the required sector by the antenna and a generally smaller coverage range. This affects the quality of the information that is being transferred, especially by 3G and 4G cellular devices. For example, this causes lower data transfer rates and more errors and interference. For cellular companies, for example, this generally results in increased operational costs, spectrum and equipment expansion and loss of income. The antenna can become misaligned with the predetermined direction in which it is supposed to point due to initial inaccurate alignment, lack of accurate direction measurements during realignment to the same or a different direction, and due to multiple gradual or sudden external factors such as wind, rain, ground movement and intentional or unintentional actions of people in its vicinity.

Typically, antennas are aligned by technicians who arrive at the site where the antenna is located. Prior art alignment methods mainly rely on external references having known geodetic coordinates. Considerable use is also made of magnetic compasses. According to an exemplary common practice, the alignment is carried out by a first technician who climbs the antenna tower and rotates an antenna that is pivotally attached to a typically vertical axle. A second technician directs him from the ground using binoculars with a built in compass, in order to determine the required pointing direction for the antenna.

Some most recent prior art methods and systems started to use GPS (Global Positioning System) signals. GPS positioning data signals can be used to accurately determine an azimuth direction or azimuth (the angle between any horizontal vector on the surface of the Earth and the meridian passing through the true North), by processing the longitude and latitude parameters of two different locations where GPS readings are taken and using, for example, the great circle method. Dedicated equipment or readily available computer software, for example the GPS Utility Program, can be used to process such double GPS positioning data and provide accurate azimuth information.

A pointing experiment using a single five-channel GPS receiver is disclosed in “A GPS Receiver with Built In Precision Pointing Capability”, IEEE, USA vol. 20/3/1990 p. 83-93 by using common hardware to perform GPS differential phase measurements from two GPS antennas. A pointing fixture assembly is used to verify performance goals in both azimuth and elevation. An optical sight rigidly fixed to a support beam on which are mounted the two antennas with a 1-m separation therebetween so as to be parallel to the pointing direction of the two antennas is used to establish a reference direction. The pointing direction can be adjusted by means of mechanical azimuth and pitch angle positioners.

As two GPS antennas are spaced by a distance of 1 m therebetween, corresponding to the tolerance range of most GPS receivers, this prior art system is subject to GPS-related positioning errors while the beam is repositioned. Consequently complex circuitry is employed that requires utilization of a high level of computer resources in order to make speedy and complicated calculations in conjunction with the electronic sight while counteracting the positioning errors and that significantly increases the cost of the system.

It is therefore an object of the present invention to provide a system and method for accurately directing directional antennas, and which overcome the problems associated with the prior art.

It is an object of the present invention to enable accurate directing of directional antennas with no more than one GPS antenna.

It is a further object of the present invention to enable better and simpler engineering and design of antenna based communications networks.

It is another optional object of the present invention to enable accurate and simple monitoring of the pointing direction of a directional antenna.

Other objects and advantages of the invention will become apparent as the description proceeds.

### SUMMARY OF THE INVENTION

The present invention is directed to an imaging system for accurately determining a pointing direction of a directional antenna, comprising a digital camera for capturing an elevation-view image of surroundings of a rotatable directional antenna, wherein said camera is suitably connected to said antenna such that the field of view of said camera is parallel to a primary transmission direction of said antenna; a processing unit for receiving and processing image data generated by said camera; and an input device for selecting a landmark that is visible in said captured image, wherein said processing unit is operable to determine a true azimuth of said selected landmark, sufficiently process said image data so as to output therefrom an angle in plan view from said antenna to said landmark, and to combine said output angle to said true azimuth of said selected landmark to determine a pointing direction of said antenna.

The present invention is also directed to a method for accurately determining a pointing direction of a directional antenna, comprising the steps of attaching a digital camera to said antenna, such that the field of view of said camera is parallel to a primary transmission direction of said antenna; by said camera, capturing an elevation-view image of surroundings of said antenna; by a processing unit, receiving and processing image data generated by said camera; by an input device, selecting a landmark that is visible in said captured image; and by said processing unit, determining a true azimuth of said selected landmark, sufficiently processing said image data so as to output therefrom an angle in plan view from said antenna to said landmark, and combining said output angle to said true azimuth of said selected landmark to determine a pointing direction of said antenna.

### BRIEF DESCRIPTION OF THE DRAWINGS

In the drawings:

FIG. 1a is a perspective view of an antenna tower on which is mounted the imaging system of the present invention, showing a technician during performance of a calibration operation;

FIG. 1b is an enlargement of FIG. 1a, showing the relative disposition of mounted digital camera;

FIG. 2a is an elevation-view image of the antenna's surroundings captured by the camera of FIG. 1b;

FIG. 2b is a plan-view image corresponding to the image of FIG. 2a;

FIGS. 3a and 3b are schematic illustrations of FIGS. 2a-2b, respectively, wherein all objects in the field of view have been removed with the exception of the antenna and the landmark;

FIG. 4 is a block diagram of an imaging system according to one embodiment of the invention;

FIG. 5 is a block diagram of an imaging system according to another embodiment of the invention;

FIG. 6 is a flowchart of a method for determining the current azimuth of a directional antenna, according to an embodiment of the invention;

FIG. 7 is a schematic illustration of the plan-view image of FIG. 3a on which is projected an elevation-view image, showing a correlation between the pixel width of the plan-view image and the camera's field of view in the elevation-view image;

FIG. 8 is a flowchart of a method for determining the angle from a directional antenna to a landmark, according to another embodiment of the invention;

FIGS. 9 and 10 are a schematic illustration of a plan-view image representing a half field of view of a camera lens in on which is projected an elevation-view image captured by the camera lens, showing first and second stages, respectively, of the method of FIG. 8; and

FIG. 11 is a flowchart of a method for tracking a change in the azimuth of directional antenna.

### DETAILED DESCRIPTION OF EMBODIMENTS

In the system and method of the present invention, an image processor is used to determine a current pointing direction of a directional antenna through imaging techniques, requiring less manpower than prior art systems.

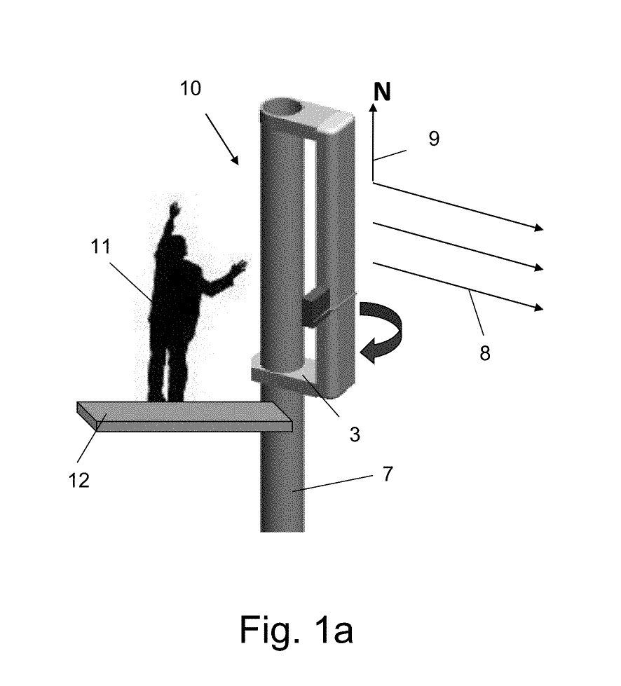

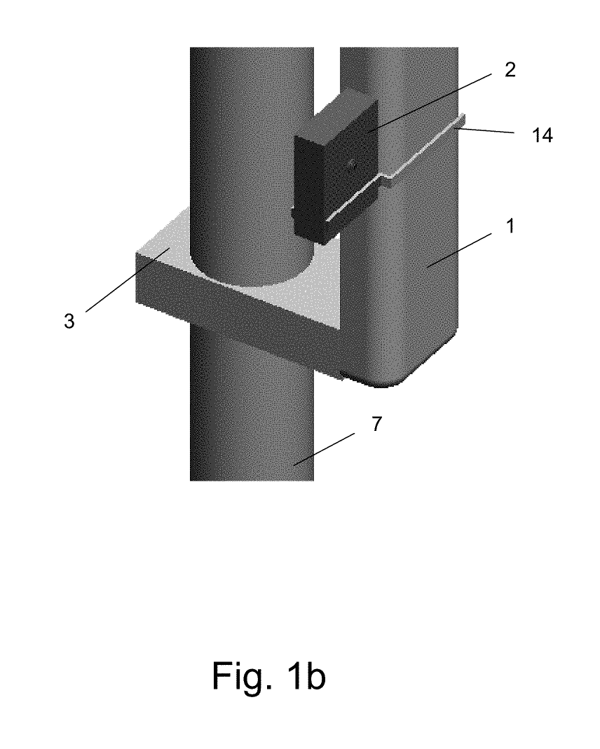

FIGS. 1a and 1b schematically illustrate a setup of the imaging system for accurately directing antennas, according to an embodiment of the present invention. A directional antenna 1 configured in this example, as a rectangular panel (the imaging system may be mounted on any antenna with other shapes, using an appropriate fixation element) as well known to those skilled in the art is pivotally attached via a connecting element 3, e.g. rectangular and perpendicular to directional antenna 1, connected to, and possibly formed with an aperture to surround, a vertical axle 7 which is mounted on an antenna tower 10. Antenna 1 has its primary transmission directions marked by the corresponding arrows 8 and 9, respectively. A digital camera 2 is mounted aside to the antenna 1, for example by means of brackets 14, such that the field of view of the camera 2 is parallel to the primary transmission direction 8 of the antenna. Initial calibration of antenna 1 may be carried out in conjunction with a technician 11 standing on a support element 12 below connecting element 3.

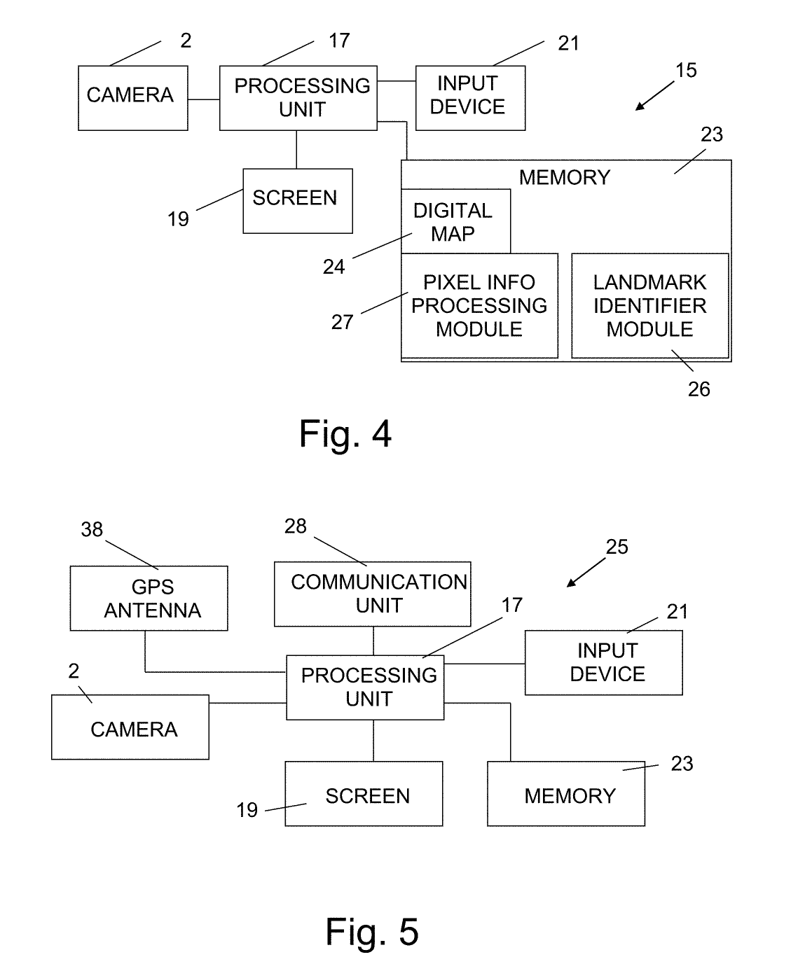

FIG. 4 schematically illustrates an imaging system 15 according to one embodiment of the invention. In addition to digital camera 2 for imaging the surroundings of the directional antenna, imaging system 15 comprises processing unit 17 for receiving and processing the image data generated by camera 2, and a screen 19 on which is displayable an image generated by processing unit 17 in response to the processed image data, which is of benefit to a technician. One or more input devices 21 for inputting information to the imaging system, for example manually, locally or offline inputting GPS information, are also provided. An exemplary input device 21 is a keypad, a mouse, a touchscreen or a user interface, which may be displayed on screen 19. Screen 19 may be housed in a casing common with processing unit 17, or alternatively may be housed in a handheld device, such as a smartphone, for example manipulated by the technician in close proximity to imaging system 15. Processing unit 17 is also configured with a memory device 23 in which is storable a digital map 24 of the antenna surroundings, a landmark identifier module 26 for marking a landmark on an image captured by digital camera 2, and a pixel information processing module 27 for processing image data associated with the landmark. Landmark identifier module 26 may be adapted to access the bitmap pixel grid of the captured image and to apply the marking in response to a selection made by an input device 21.

FIG. 5 schematically illustrates an imaging system 25 according to another embodiment of the invention. In this embodiment, imaging system 25 is adapted to remotely monitor the current pointing direction of the directional antenna, and further comprises, in addition to the units illustrated in FIG. 4, a communication unit 28 in data communication with processing unit 17. Communication unit 28 is generally configured with a transceiver and with other communication and data transmission equipment for remotely transmitting the digital map, for example from a server, or for remotely transmitting a technician input to processing unit 17. A single local GPS antenna 38 may be provided to input the antenna-related GPS data to processing unit 17, and may receive the GPS data from a remote server.

Since digital camera 2 is positioned such that its field of view is parallel to the primary transmission direction of the antenna, an image captured by the camera is indicative of the antenna's pointing direction. As will be described hereinafter, the antenna's pointing direction is determined by calculating the antenna's location with respect to the camera's field of view relative to a reference landmark location.

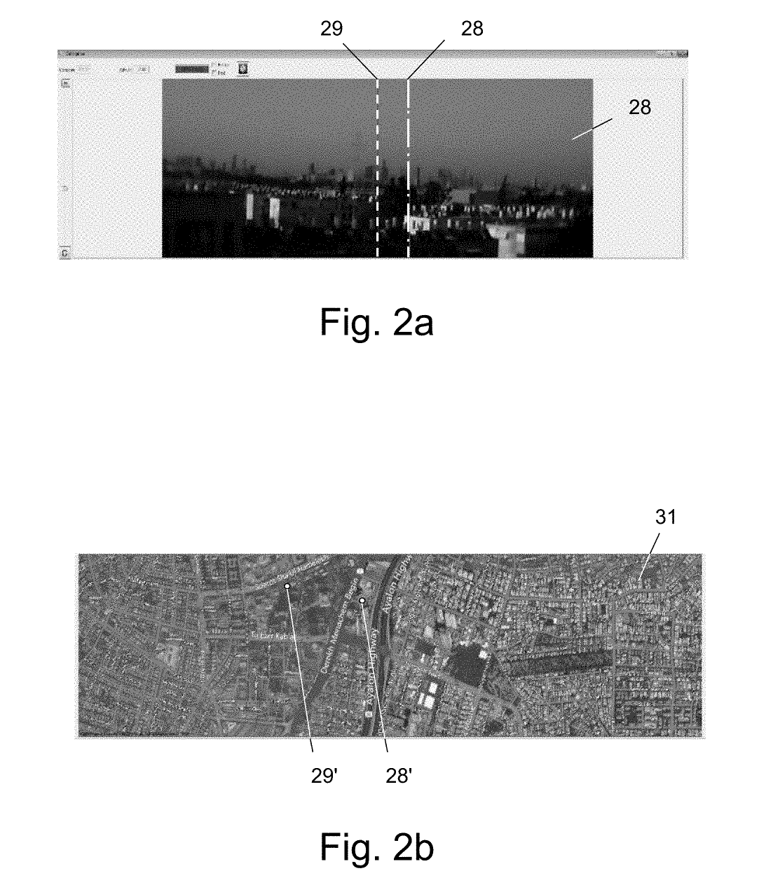

FIG. 2a is a frame 22 of an image of the antenna's surroundings in elevation which has been captured by the camera. After the image has been captured, landmark identifier module 26 (FIG. 4) sufficiently processes the image to allow one of the objects visible in the image to be selected as a landmark with one of the input devices 21, by the technician having the responsibility to accurately direct the antenna. Following manipulation of the input device, the selected landmark, which may be a prominent building such as a high-rise building, is made visible by a distinctive line 28, e.g. a dashed line, generated by the landmark identifier module and vertically appearing on the captured image. Another distinctive line 29, e.g. a dotted line, is also generated to appear vertically at the center line of the rectangular frame 22, to represent the antenna's location relative to the landmark as well as the camera's field of view

FIG. 2b shows a satellite image 31 in plan view of the same antenna surroundings, for example derived from the Google Earth program, on which the same selected landmark appears as dot 28′ and the antenna's location appears as dot 29′. Satellite image 31 associates geographic coordinates with one or more landmarks. It will be appreciated that any other type of digital geographic image may also be employed. It is also appreciated that any additional land cover layer can be uploaded on top of the geographic image to help identifying the landmark (such as a layer of all the cell sites of the cellular operator, municipal building etc.)

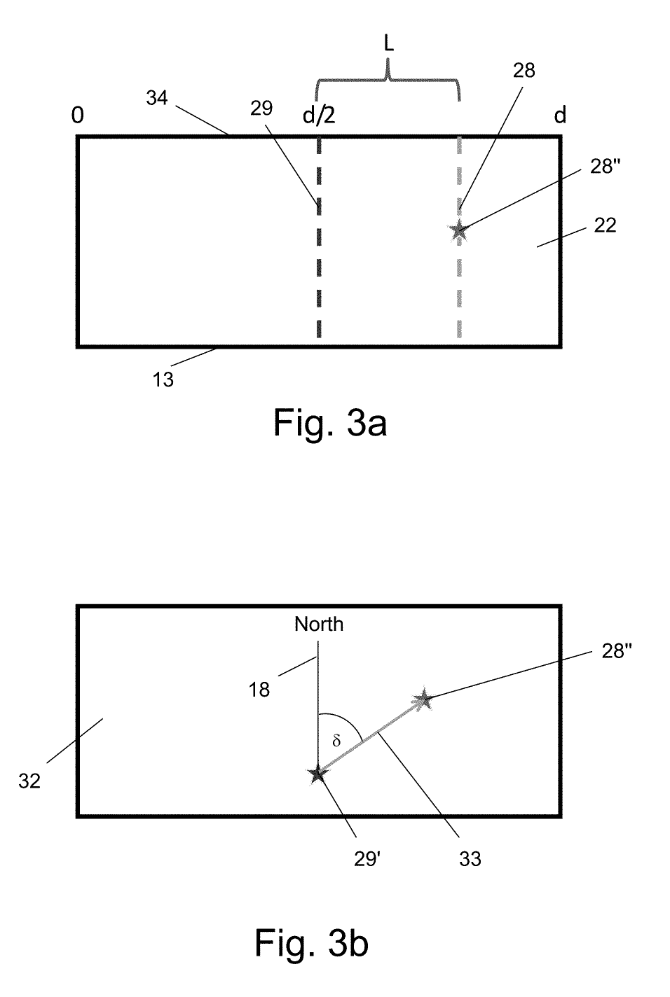

FIGS. 3a and 3b show a schematic illustration of FIGS. 2a-2b, respectively, wherein all objects in the field of view have been removed for clarity with the exception of the antenna and the landmark. The camera's field of view included within frame 22 in elevation view is defined by a rectangle of length d. The relative Azimuth of the antenna is represented by line 29 positioned at the center line of frame 22, i.e. at a distance d/2 along the frame in FIG. 3a, and extending from bottom edge 13 to upper edge 34 of frame 22. Landmark 28″, which is represented by line 28 extending from bottom edge 13 to upper edge 34, in turn is shown to be offset from center line 29 by a horizontal distance L.

Another image is illustrated in plan view in FIG. 3b which represents the satellite image, and indicated as 32. Plan-view image 32 is shown to have an upper edge and a lower edge. Antenna 29″, represented as a star in FIG. 3b, is shown to be separated from the selected landmark 28″, also represented as a star. Line 33 extending from landmark 28″ to antenna 29″ delimits the true azimuth δ, or the angle from true north 18 to landmark 28″ in a clockwise direction.

One significant aspect of the present invention is the ability to determine the pointing direction, or azimuth, of the directional antenna in plan view from the image captured by the camera in elevation view. As the azimuth is defined in plan view, the processing unit is operable to convert the representation of the antenna and landmark in elevation view to the corresponding projection in plan view and to thereby derive the antenna's azimuth according to the image processing techniques that will be described hereinafter.

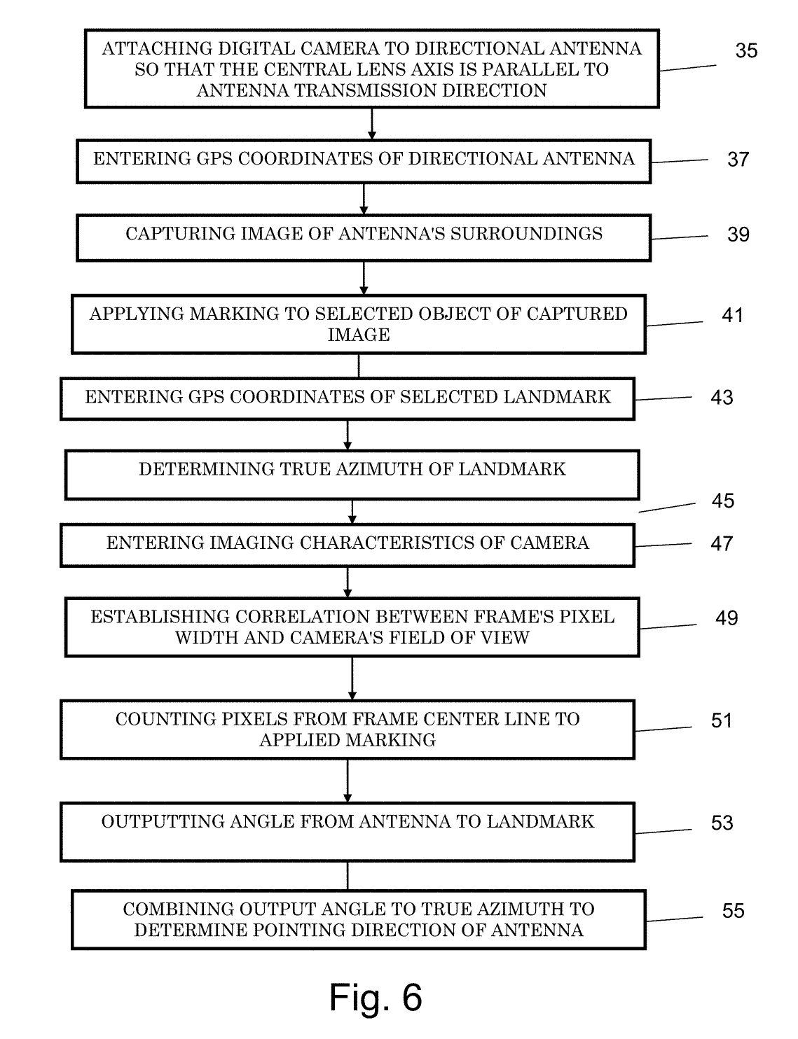

FIG. 6 is a flowchart of a method for determining the current azimuth of the antenna according to one embodiment of the invention, based on the locations of both the antenna and the landmark, which may be known, and on an image captured at a direction parallel to the pointing direction of the antenna.

Firstly, the digital camera is attached by an attachment element to the directional antenna in step 35 in such a way that the longitudinal axis at the center of the camera's lens is parallel to the antenna's primary transmission direction. The GPS coordinates of the directional antenna are obtained, for example by means of a GPS antenna or from a data source, and are entered to the processing unit via the input device, or automatically in step 37.

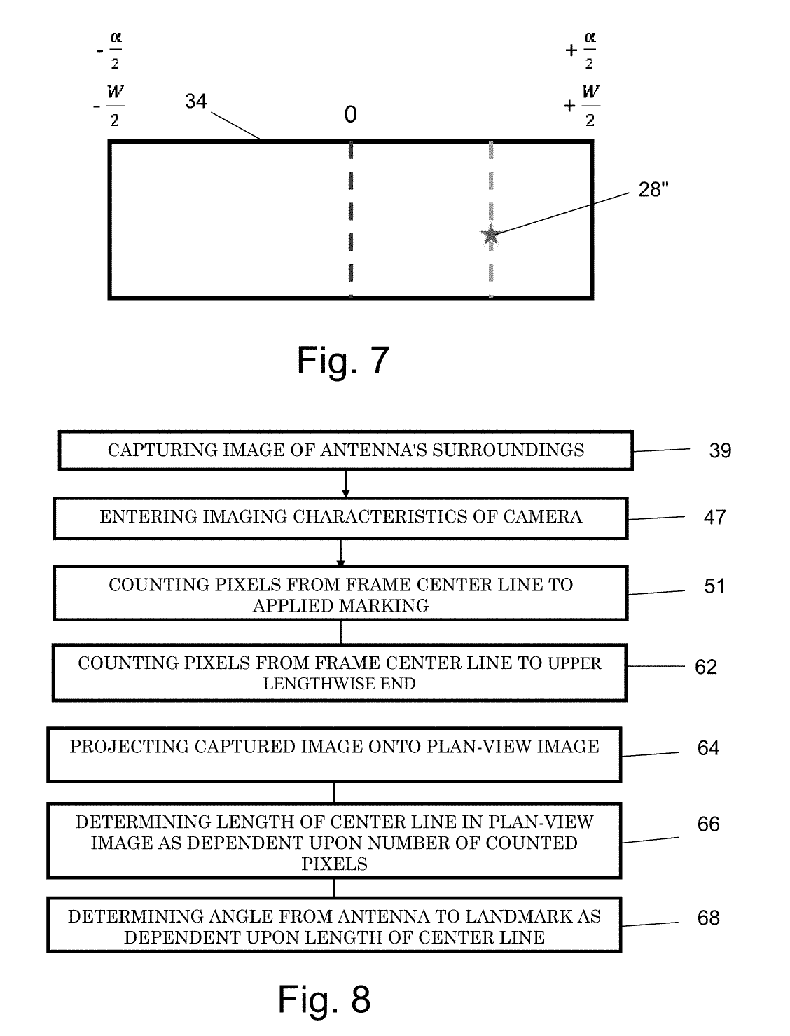

After the digital camera captures an image of the antenna's surroundings in step 39, the user, such as a technician, selects a landmark that is visible in the captured image. The landmark identifier module operates in conjunction with the operating system of the processing unit to allow an input device to apply a predetermined marking to a selected object of the captured image in step 41. The GPS coordinates of the landmark are entered to the processing unit in step 43, either automatically from the digital geographic image or manually from a data source via the input device, whereupon the processing unit determines the true azimuth δ of the landmark in step 45 based on the entered GPS coordinates of the directional antenna and of the landmark. The imaging characteristics of the camera, including its resolution in terms of W pixels per frame for a given magnification and the angular field of view α of its lens, are also entered to the processing unit in step 47. The processing unit establishes in step 49, in response to the entered imaging characteristics, a correlation between the pixel width W of the frame, which is obtainable in elevation view, and the camera's angular field of view α with respect to center line 29 of image 32, which is obtainable in plan view, as schematically illustrated in FIG. 7. As explained above, the processing unit causes the frame captured in elevation view to be projected onto an image in plan view, and consequently pixel width W is the number of pixels that are projected onto the upper edge of the image in plan view which is delimited by field of view α.

In step 51, the pixel information processing module counts the number of pixels in the captured image from its center line 29, representing the azimuth of the antenna, to the recently applied marking, representing the location of the landmark. The processing unit outputs in step 53, from the counted number of pixels and the established correlation W/α between pixel width and field of view, the angle β as viewed in plan view from the directional antenna to the landmark based on the current viewing angle of the camera and shown in FIG. 3a, and combines angle β to the true azimuth δ of the landmark to determine the true azimuth or pointing direction θ of the directional antenna in step 55. If angle β is in the clockwise direction from true north, then angle β is subtracted from true azimuth δ. Otherwise angle β is added to true azimuth δ.

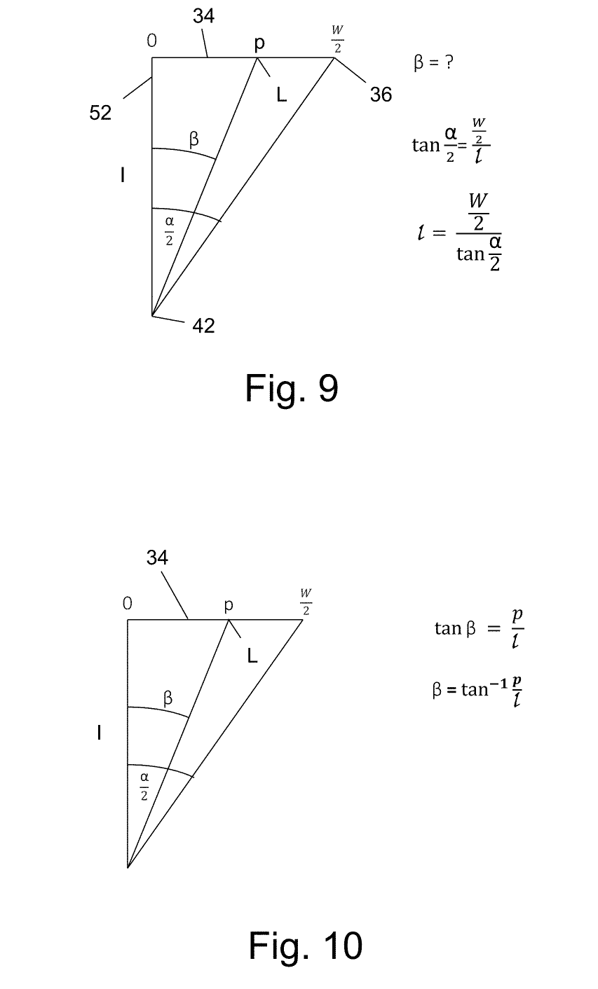

Alternatively, as shown in FIGS. 8-10, angle β is determined trigonometrically. After the image has been captured in step 39 and the imaging characteristics of the camera have been entered in step 47, the pixel information processing module counts in step 51 the number of pixels p in the captured image in elevation from its center line 29 (FIG. 3a), representing the azimuth of the antenna, to the marking at distance L representing the location of the landmark, as well as in step 62 the number of pixels W/2 in the captured image from its center line 29 to the upper lengthwise end of the frame at distance d. The captured frame is then projected in step 64 onto an image in plan view of the antenna's surroundings, such that the number of pixels W/2 is equated to the distance along upper edge 34 of plan-view image 32 from center line 52 thereof to upper lengthwise end 36 thereof, and the number of pixels p is equated to distance L. Afterwards, the processing unit determines, in step 66, the length 1 in plan-view image 32 along center line 52, corresponding to the axis of the lens, to its upper edge 34. Since the tangent of the half field of view (FOV) α/2 of the camera lens from the center line 52 to the upper lengthwise end 36 of the frame is defined by the relation:

tan(α/2)=(W/2)/l,

the processing unit determines that the value of 1 is equal to:

l=(W/2)/tan(α/2).

In step 68, the processing unit determines the value of angle β from the directional antenna to the landmark by the relation:

tan β=p/l,

which is equal to:

β=tan⁻¹p/l.

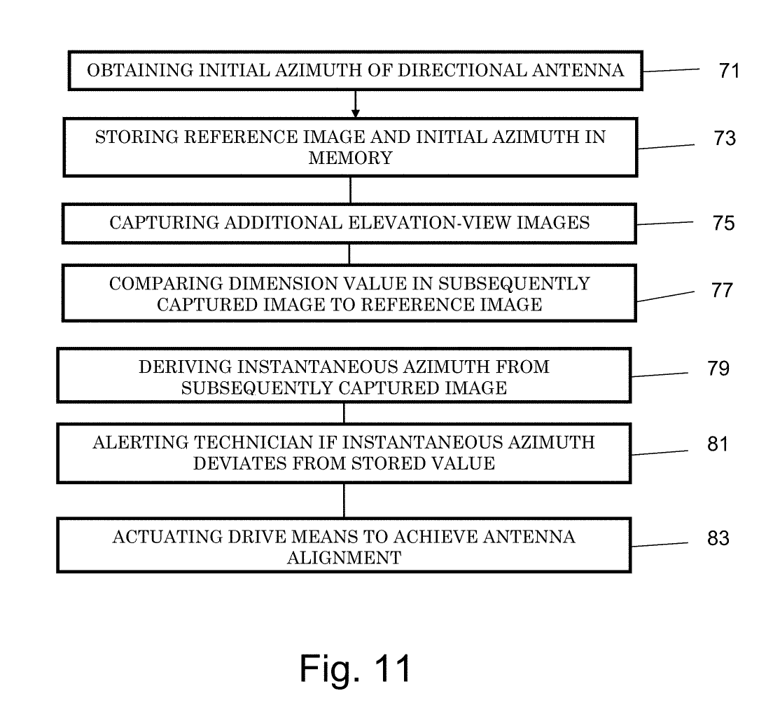

FIG. 11 illustrates the process of tracking any changes in the azimuth of the antenna. After an initial azimuth of the directional antenna has been obtained in step 71, as described hereinabove, the captured elevation-view image is stored in memory device 23 (FIG. 4) as a reference image in step 73. The initial azimuth is also stored in memory. Additional elevation-view images are subsequently captured in step 75, and a dimension value, such as the distance between two objects or the size of an object, in a subsequently captured image is compared to a corresponding dimension value in the reference image in step 77. If there is no significant change in the dimension value, the process is terminated; however, if there is a change greater than a predetermined value, then the instantaneous azimuth of the antenna is derived from the subsequently captured image in step 79. The technician is alerted in step 81 if the instantaneous azimuth deviates by greater than a predetermined threshold than the stored value, to indicate that the antenna has to be aligned. In order to properly align the antenna, the technician may actuate in step 83, whether locally or remotely, drive means for causing the antenna to rotate about axle 7 (FIG. 1b) for a suitable angular distance. The actuator of the drive means may be in data communication with the processing unit in order to control the rotation.

The above examples and description have of course been provided only for the purpose of illustration, and are not intended to limit the invention. As will be appreciated by a person skilled in the art, the invention can be carried out in a great variety of ways in addition to those described above, all without exceeding the scope of the invention.

1. An imaging system for accurately determining a pointing direction of a directional antenna, comprising:
a) a digital camera for capturing an elevation-view image of surroundings of a rotatable directional antenna, wherein said camera is fixedly connected to said antenna such that a longitudinal axis at a center of a lens of said camera is always parallel to a primary transmission direction of said antenna;
b) a pixel information processing unit for receiving and processing image data generated by said camera during capturing of said elevation-view image; and
c) an input device for selecting a landmark that is visible in said captured elevation-view image,
wherein said processing unit is operable to—
i. determine a true azimuth of said selected landmark;
ii. sufficiently process said image data so as to:
define a horizontal distance from a center line of said elevation-view image to a representation of said selected landmark on said elevation-view image;
count a number of pixels, in said elevation-view image, along a line corresponding to said distance;
derive, from said counted pixels, an angle in plan view from a pointing direction of said antenna to said true azimuth of said selected landmark; and
iii. combine said derived angle to said true azimuth of said selected landmark to determine the pointing direction of said antenna.

2. The imaging system according to claim 1, further comprising a landmark identifier module for applying a marking on the captured image at a location of the selected landmark, wherein the pixel information processing module is operable to count a number of pixels from the center line of the captured image to said applied marking.

3. The imaging system according to claim 2, wherein the processing unit is operable to sufficiently process said image data so as to output therefrom the derived angle in plan view from a pointing direction of said antenna to said true azimuth of said landmark by establishing a correlation between a pixel width of the captured image and a field of view of the camera and by outputting said derived angle in response to the number of counted pixels from the center line of the captured image to the applied marking.

4. The imaging system according to claim 2, wherein the processing unit is operable to sufficiently process said image data so as to output therefrom the derived angle in plan view from a pointing direction of said antenna to said true azimuth of said landmark by—
a) projecting the captured image onto a plan-view;
b) determining length of the center line of the lens of the camera in said plan-view extending from the focal point of said lens to a point being the protection of the center line of the captured elevation-view image onto said plan view, as dependent upon a pixel width of the captured image and a field of view of the camera; and
c) determining the derived angle in plan view from a pointing direction of said antenna to said true azimuth of said landmark as dependent upon said determined length of the center line of said lens in said plan-view and the number of counted pixels from the center line of the captured elevation-view image to the applied marking.

5. The imaging system according to claim 1, further comprising a bracket for fixedly connecting the camera to the antenna in such a way that the field of view of the camera is parallel to the primary transmission direction of the antenna.

6. The imaging system according to claim 1, further comprising a communication unit in data communication with the processing unit for remotely transmitting an input from the input device to the processing unit.

7. The imaging system according to claim 6, wherein the input transmitted from the input device to the processing unit is selected from the group consisting of selection of the landmark, GPS coordinates of the selected landmark, GPS coordinates of the directional antenna, imaging characteristics of the digital camera, an indication to capture the elevation-view image, and an indication to actuate drive means for causing the antenna to rotate about a vertical axis for a controlled angular distance.

8. The imaging system according to claim 1, wherein the processing unit is configured with a memory device in which is stored a digital map of the antenna surroundings.

9. The imaging system according to claim 8, wherein the processing unit is configured to automatically enter GPS coordinates of the selected landmark from the digital map.

10. The imaging system according to claim 1, further comprising a GPS antenna in data communication with the processing unit for providing GPS coordinates of the directional antenna.

11. A method for accurately determining a pointing direction of a directional antenna, comprising the steps of:
a. fixedly attaching a digital camera to said antenna, such that a longitudinal axis at a center of a lens of said camera is always parallel to a primary transmission direction of said antenna;
b. by said camera, capturing an elevation-view image of surroundings of said antenna;
c. by a pixel information processing unit, receiving and processing image data generated by said camera during capturing of said elevation-view image;
d. by an input device, selecting a landmark that is visible in said captured image; and
e. by said processing unit—
i. determining a true azimuth of said selected landmark;
ii. sufficiently processing said image data so as to define a horizontal distance from a center line of said elevation-view image to a representation of said selected landmark on said elevation-view image;
iii. counting a number of pixels, in said elevation-view image, along a line corresponding to said distance;
iv. deriving, from said counted pixels, an angle in plan view from a pointing direction of said antenna to said selected landmark; and
v. and
vi. combining said derived angle to said true azimuth of said selected landmark to determine the pointing direction of said antenna.

12. The method according to claim 11, wherein the step of determining a true azimuth of said selected landmark is carried out by entering GPS coordinates of the selected landmark.

13. The method according to claim 11, further comprising the steps of applying a marking on the captured image at a location of the selected landmark, and counting a number of pixels from the center line of the captured image to said applied marking.

14. The method according to claim 13, wherein the processing unit sufficiently processes said image data so as to output therefrom the derived angle in plan view from the pointing direction of said antenna to said true azimuth of said landmark by establishing a correlation between a pixel width of the captured image and a field of view of the camera and by outputting said derived angle in response to the number of counted pixels from the center line of the captured image to the applied marking.

15. The method according to claim 13, wherein the processing unit sufficiently processes said image data so as to output therefrom the derived angle in plan view from the pointing direction of said antenna to said true azimuth of said landmark by projecting the captured image onto a plan-view, determining length of the center line of the lens of the camera in said plan-view extending from the focal point of said lens to a point being the protection of the center line of the captured elevation-view image onto said plan view, as dependent upon a pixel width of the captured image and a field of view of the camera, and determining the derived angle in plan view from the pointing direction of said antenna to said true azimuth of said landmark as dependent upon said determined length of the center line of said lens in said plan-view and the number of counted pixels from the center line of the captured elevation-view image to the applied marking.

16. The method according to claim 11, further comprising the steps of:
a) deriving an instantaneous pointing direction of the antenna from a subsequently captured image;
b) alerting a technician if said instantaneous pointing direction deviated from a stored value; and
c) actuating drive means to achieve a desired antenna alignment.
